(19) United States
(12) Patent Application Publication
(10) Pub. No.: US 2004/0142067 A1
(43) Pub. Date: Jul. 22, 2004

(54) Process and apparatus for manufacturing beer vinegar, and beer vinegar

(76) Inventors: Frederic Stephane Le Clerc, Dijon (FR); Veronique Paule-Marie Matt, Genay (FR)

Correspondence Address: UNILEVER, PATENT DEPARTMENT, 45 RIVER ROAD, EDGEWATER, NJ, 07020, US

(21) Appl. No.: 10/476,130

(22) PCT Filed: Apr. 25, 2002
(86) PCT No.: PCT/EP02/04580

(30) Foreign Application Priority Data
Apr. 27, 2001 (FR) 0105899

(51) Int. Cl. C12J 1/00

(52) U.S. Cl. 426/17

(57) ABSTRACT

Process for manufacturing beer vinegar, and beer vinegar thus obtained Process for producing beer vinegar from beer, in which the process comprising the steps of; a) a step of partial bonding to reduce the content of acetic bacteria and to clarify the beer, b) a step of filtering the beer from step a) to remove the yeasts, c) a step of decarboxylation of the beer of step b), d) gradual acetification of the beer until a product whose acetic degree is compatible with the designation “vinegar” is obtained, and e) clarification of the product of step d) to remove the cloudiness. Beer vinegar produced by the process, and apparatus for carrying out the process is also provided.

### FIELD OF THE INVENTION

The present invention relates to the technical field of manufacturing vinegars, and more specifically to processes for manufacturing or producing acetified beer, in order to obtain a beer vinegar.

### BACKGROUND OF THE INVENTION

The present invention relates to a process for producing or manufacturing beer vinegar from beer using acetic acid bacteria, in which process the beer is gradually acetified until a final product whose alcoholic degree is compatible with the designation “vinegar” is obtained, and the product obtained is then clarified to remove the cloudiness.

The present invention also relates to a beer vinegar corresponding to the legal designation of vinegar, and also to a plant for carrying out the manufacturing process.

It is already known practice, in the art, to produce beer vinegar from beer using acetic acid bacteria, by gradually acetifying the beer. Such a method is known, for example, under the name of the “orleanaise” traditional method.

Such a method consists essentially in performing a gradual acetification of the beer leading to the production of a vinegar starting with an initial amount of beer, and by acetification on wood chips, or at the surface and without aeration. Such a method is found not to satisfy industrial requirements because it is a long procedure as the acetification of the beer up to an acetic degree that is compatible with the legal designation “vinegar” (6° ac) e.g. in France takes place over a period of at least one month. Moreover, the product obtained is cloudy and, despite the use of decantation steps, a permanent cloudiness remains in the vinegar, which is reflected by a relatively high turbidity index. Thus the vinegar obtained by such traditional methods does not have a good visual aspect, and this is thus detrimental to its commercialization.

JP 01 132369 (Asahi Breweries Ltd.) discloses a method for the degassing of a sparkling beverage, such as beer, to produce beer vinegar.

JP 02 231068 discloses a method for the production of acetic acid fermented liquid by adding cross linked chitosan beads into an alcohol containing raw material such as beer.

GB 1 274 195 discloses the removal of carbon dioxide dissolved or held in suspension in a liquid by the addition of nitrogen to the liquid.

The publication “Proceedings of the Second Aviemore conference on malting brewing and distilling”, held at Aviemore Centre, 19-23 May 1986 (abstract no. XP-001039846 title “The use of nitrogen to improve beer foam”, by J. W. Avis et al.) discloses a method for the determination of the amount of dissolved nitrogen in beer.

H. Wüstenfeld in “Lehrbuchder Essigfabrikation” published 1930 by Verlag Paul Parey (abstract no. XP-002185774) discloses principles of vinegar production.

J. White in “Malt vinegar manufacture”, Process Biochemistry, Vol. 15 no. 10, 1970, pages 54-56 (abstract no. XP001042189) discloses details of malt vinegar manufacture.

The object of the present invention is consequently directed towards providing a remedy to the various drawbacks mentioned above, and towards proposing a novel process for producing beer vinegar that can be performed industrially and that makes it possible to obtain in a commercially acceptable time a product of the legal designation “vinegar”.

Another object of the invention is directed towards proposing a novel process for producing beer vinegar which makes it possible to obtain a beer vinegar with good appearance characteristics, especially visual appearance, and good taste or organoleptic characteristics.

Another object of the invention is directed towards proposing a novel process for producing beer vinegar that is capable of avoiding the appearance of foam.

Another object of the invention is directed towards proposing a novel process for producing beer vinegar that is capable of promoting a rapid and controlled acetification of the beer.

Another object of the invention is directed towards proposing a novel beer vinegar that can be obtained under economic industrial conditions, while at the same time having a good appearance and excellent taste characteristics.

### SUMMARY OF THE INVENTION

The objects of the invention are achieved by means of a process for producing beer vinegar from beer, the process comprising the steps of;

a) partial bonding to reduce the content of acetic bacteria and to clarify the beer;

b) filtering the beer from step a) to remove the yeasts,

c) decarboxylation of the beer of step b),

d) gradual acetification of the beer until a product whose acetic degree is compatible with the designation “vinegar” is obtained, and

e) clarification of the product of step d) to remove the cloudiness.

The objects of the invention are achieved by a beer vinegar produced according to the process of the invention. This beer vinegar has a carbon dioxide content less than or equal to 2 g/l of CO₂.

The objects of the invention are also achieved using a plant for carrying out the process according to the invention, the plant comprising:

at least one beer storage tank,

at least one beer receiving tank connected to the storage tank via a conduit,

a nitrogen injector mounted on the conduit at a sufficient distance from the receiving tank to allow good dissolution of the nitrogen in the beer.

### DETAILED DESCRIPTION OF THE INVENTION

Other advantages and aspects of the invention will be explained in further detail below and with the aid of the drawings, which are supplied purely for the purposes of explanation and with no limiting nature, in which:

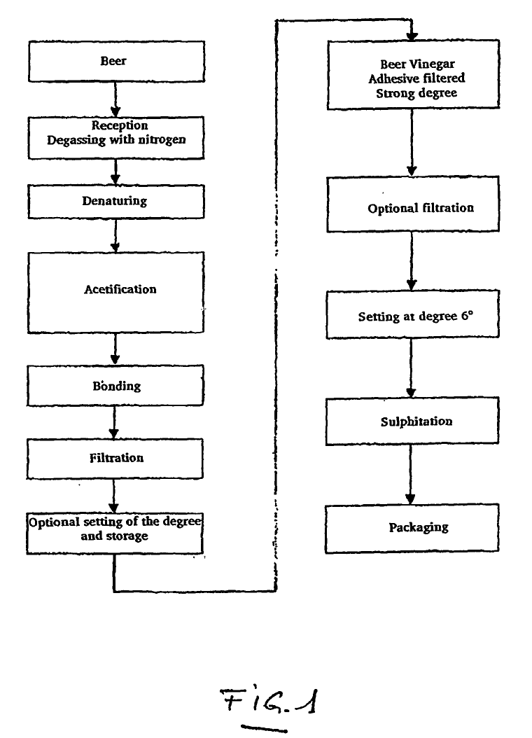

FIG. 1 shows, diagrammatically, the main steps in the process for producing beer vinegar in accordance with the invention.

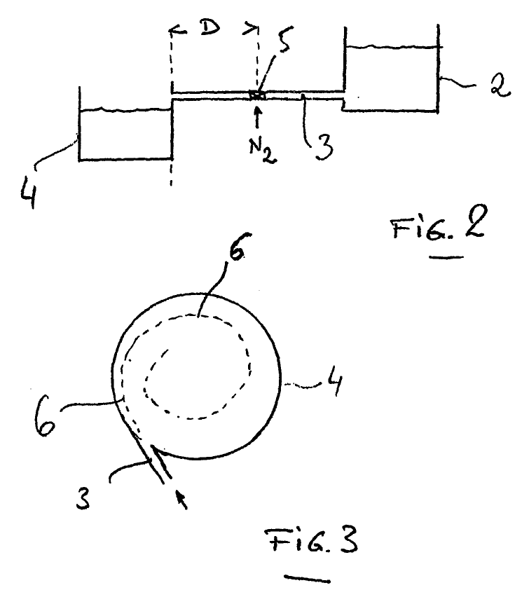

FIG. 2 shows, in a view in diagrammatic cross section, an example of the conduit for the decarboxylation step in accordance with the invention.

FIG. 3 shows, in a diagrammatic top view, a detail of the filling of a beer receiving tank during the decarboxylation step in accordance with the invention.

In general, a process for producing beer vinegar from beer using acetic acid bacteria is a process in which the beer is gradually acetified until a final product, vinegar, whose acetic degree is greater than or equal to 6° is obtained, so as to be compatible with the legal provisions in force enabling it to obtain the designation “vinegar”.

Acetification is thus one of the essential steps of a process for producing a beer vinegar and, according to the invention, it will advantageously be performed without seeding with acetic acid bacteria and in cells immersed in batch or semi-continuous mode, so as to allow the rapid production of a standardized beer vinegar that satisfies the legal designation of vinegar.

The beer from which a beer vinegar will be obtained after the process in accordance with the invention is a liquid medium which, on account of the presence of proteins, essentially associated with the presence of malt, carbon dioxide (CO₂) and yeast residues, is a product capable of generating an abundant foam. It is consequently found that these last three parameters are essential impediments to the correct progress of an industrial beer acetification process, this production process furthermore taking place in an aerobic phase. Moreover, the existence of yeast residues in the beer is of a nature to create a risk of deceleration, or even of forced inhibition of the growth of the acetic acid bacteria at the expense of the yeasts, which constitutes another important factor liable to be detrimental to the correct progress of the beer acetification phase.

Finally, the malt proteins and polyphenols contained in beer are responsible for the appearance of cloudiness in the product obtained during an acetification, which is difficult to remove by the standard clarification methods.

Thus, one important characteristic of the invention consists in performing a process for the industrial production of beer vinegar, from beer using acetic acid bacteria, which comprises, prior to the acetification step, a decarboxylation step. This step is specifically directed towards avoiding or reducing the formation of foam during the subsequent acetification step, such a step preferably being ensured by injecting a separating gas. Advantageously, nitrogen (N₂) is used, on account of its food nature (acceptance in the art for use with food products). As a variant, any gas or mixture of gases of food nature having the same characteristics as nitrogen may also be used.

Advantageously, the injected gas will contain at least 95% nitrogen, the remainder of the mixture being formed by air or neutral gases. This decarboxylation step (removal of CO₂) is thus a step of degassing the beer as much as possible.

In general, the nitrogen will be injected continuously, this step substantially and consequently avoiding or reducing the production of foam during the acetification step.

Another step of the invention consists in prior to the decarboxylation step, a step of filtering the beer, in order specifically to remove all or some of the yeasts present in the beer and recognized as being responsible for cloudiness in the product obtained at the end of the process.

Such a removal also makes it possible to avoid a competition or a domination of the growth of yeasts over the growth of the acetic acid bacteria responsible for converting the beer to vinegar.

Such a step thus facilitates a general increase in the yield of the production process in accordance with the invention, by especially allowing a reduction in the acetification time.

Finally, another step of the invention is that the filtration step is preceded by a step of partial bonding of the beer, so as to reduce the content of emulsifying proteins and to clarify the beer. The aim of such a step is to avoid or reduce the appearance of a cloudy final product, and to a certain extent also to reduce the subsequent and future appearance of foam.

Thus, in general, the process for producing beer vinegar in accordance with the invention consists, for example starting with an amber beer at 7.8°, in advantageously subjecting it to a first bonding step, as mentioned above, for example by incorporating a silica gel, followed by a filtration step to remove the yeasts, the initial treated beer advantageously being able to be maintained without pressure of carbon dioxide.

Thereafter, and as illustrated especially in FIGS. 1 to 3, the beer stored in a storage tank 2 undergoes a decarboxylation step comprising an injection of nitrogen (N₂) performed at a rate of 1 to 1.5 volumes of nitrogen per volume of beer.

As illustrated in FIG. 2, the injection of nitrogen is carried out in a conduit 3 connecting the beer storage tank 2 to the beer receiving tank 4. Advantageously, the injection point at which an injector 5 for injecting nitrogen into the conduit 3 is mounted, is sufficiently remote from the receiving tank 4 to allow a good separating action of the nitrogen in the beer within the conduit 3 to strip the CO₂ out of the beer. The action of the nitrogen should be understood as an action for the micromechanical separation of the CO₂ from the volume of beer. Thus, maintaining a minimum distance D between the injection point (injector 5) and the receiving tank 4 makes it possible to ensure a good separation of the carbon dioxide present in the beer, thus making it possible subsequently, in the said receiving tank, to ensure its separation by gravity, and then its removal.

Advantageously, it is found that the injection point (injector 5) needs to be at least 15 m and preferably at least 20 m away from the filling tank 4 in order to obtain good results.

In a known manner, the injection of nitrogen is performed with a sinter containing a microporous metal portion performing the injection, and also using a pump connected to the injector 5.

Advantageously, to further improve the separation of the carbon dioxide present in the beer and to promote its removal, the receiving tank 4 is filled, as illustrated in FIG. 3, tangentially to the wall of the receiving tank 4, so as to create a vortex 6 that increases the area of exchange between the air and the beer in order thus to bring about the extraction of the CO₂ and the nitrogen from the liquid. The conduit 2 thus opens substantially tangentially to the wall of the receiving tank 4.

The result is further improved if, advantageously, the receiving tank 4 is filled from the top of the tank 4.

The plant for carrying out the process according to the invention thus comprises:

at least one beer storage tank 2,

at least one beer receiving tank 4 connected to the storage tank 2 via a conduit 3,

a nitrogen injector 5 mounted on the conduit a sufficient distance D from the receiving tank 4 to allow a good separating action of the nitrogen in the beer.

The plant according to the invention is characterized in that the distance D is at least 15 m and preferably at least 20 m.

The plant according to the invention is also characterized in that the conduit 3 opens substantially tangentially in the wall of the receiving tank 4 to create a vortex 6.

Thus, with the receiving tank 4 being in the open air, the carbon dioxide can evaporate off. However, a certain amount of foam formation may possibly be observed in the receiving tank 4, and may be subsequently removed by mixing with water.

Thereafter, and as illustrated in FIG. 1, a step of denaturing the beer, required by legal restrictions, is performed. This denaturing step involves denaturing the alcohol present in the beer by adding at least 10% beer vinegar.

The process in accordance with the invention then consists in performing the actual acetification step in standard equipment known as an acetator. Conventionally, the acetator, which may be likened to a fermenter, comprises a turbomixer which sucks the ambient air to form a series of microbubbles in the volume contained in the tank, so as to promote the growth of the natural acetic acid bacteria present, without prior seeding, in the beer.

The acetification is thus performed in immersed cells with aeration with air limited to the start of the acetification step, followed by a gradual or non-gradual increase in the aeration during the acetification, while optionally using mechanical foam-breaking means.

Specific “foods” may also be added to promote the growth of the acetic acid bacteria.

After the decarboxylation step, the residual carbon dioxide content of the beer is less than or equal to 2 g/l of CO₂ and preferably less than or equal to 0.5 g/l of CO₂, the residual alcohol being less than or equal to 0.35%.

Thereafter, the process according to the invention includes an additional bonding step intended to remove all or some of the acetic acid bacteria present, in order specifically to reduce the cloudiness of the product obtained.

Advantageously, the bonding step comprises the addition of overactivated adhesives, preferably of bentonite, comprising little or no metals or minerals, so as to avoid the subsequent appearance of cloudiness over time.

Next, the process according to the invention comprises a filtration step. The aim of this filtration step is to reduce the turbidity of the vinegar obtained, such that its value is less than or equal to 3 (by optical reading) and such that its clogging index is less than or equal to 30.

The process according to the invention then continues with an optional step of adjusting the vinegar to a standardized acetic degree of 6°. This acetic degree of 6° is essential to obtain the legal designation “vinegar”, since, at the start, the initial acidity value is of the order of 7 to 8°, whereas a value of at least 6° must imperatively be obtained. The optional degree adjustment is carried out by simple addition of water.

After this optional step of adjustment to the necessary acetic degree, the resulting product, namely the beer vinegar, is stored while awaiting its subsequent packaging. During storage, and before its final packaging, it may be necessary to carry out complementary and additional steps consisting in carrying out a filtration and in rechecking the acetic degree, in order, if necessary, to adjust it once again to its legal value of 6°.

It may also be necessary, or even essential, to perform a step of sulphiting (addition of SO₂) which acts as an antioxidant, in order to scavenge oxygen that might oxidize the proteins still present in the beer vinegar.

The aim of this step is to slow down the appearance of cloudiness in the vinegar so as to conserve a good visual appearance, and it is carried out at any moment before the packaging operation.

The final packaging step is carried out in a conventional manner, for example by injection, without the appearance of foam.

At the end of the production process in accordance with the invention, a beer vinegar whose carbon dioxide content is less than or equal to 2 g/l of CO₂ and preferably less than or equal to 0.5 g/l of CO₂ is consequently obtained rapidly (for example in 4 days) and without excessive formation of foam. On the other hand, without the decarboxylation step, the CO₂ content in the finished product would be of the order of 2 to 3 g/l of CO₂.

The present invention will be further illustrated with reference to the following non-limiting example.

Example of the Manufacture and Packaging of Vinegar

a) Receipt

100 hl of amber beer at 7.8° are received. The beer arrives in an isothermal vat not maintained under a pressure of CO₂, with a residual content of 3 g/l of dissolved CO₂. The beer has been partially bonded beforehand to silica gel and then filtered in order to remove the yeasts.

b) Degassing

The vat is decanted into a P7 stainless steel tank via a centrifugal pump. Nitrogen is injected at the outlet of the pump (via an injector+sinter) for injecting nitrogen: 1.5 v/v beer, injection pressure 2 bar. Decantation rate ranging from 45 to 70 hl/H.

Preferably, 15 m of pipe separates the nitrogen injector from the P7 tank; this allows the nitrogen to dissolve and thus to strip out the CO₂ from the beer. The tank is filled from the top via a stainless-steel tube arriving tangentially to the wall: the aim is to increase the gas/liquid surface area and thus to allow the CO₂ to evaporate off.

c) Acetification

The beer is denatured with 10 hl of beer vinegar, the objective being to promote the starting and to inhibit the growth of yeasts.

Transfer between the P7 tank and the Lyons acetator (equipped with a mechanical foam breaker), via a 250 hl/H pump, of 98.5 hl of degassed beer. Addition of foodstuffs to promote the growth of acetic bacteria. Beer at 1.65° ac initial and temperature of 11° C.

Start-up in a closed air circuit.

Result:

From the start, formation of a very dense foam: foam breaker switched on.

Starting beginning at 24 H (regression of the acidity). At 48 H, 2.5° ac: control of the air in the open circuit (40 m³/H). The foam is slightly less dense. The acidity inhibits the formation of foam.

The rate of acetification increased from 0.05 to 0.17°/H passing via 0.15°/H at T0+72H.

Results in accordance with the pilot tests.

After 4 days: acidity at 7.72°/residual alcohol at 0.35°. The acetification yield is 85%. The foam no longer poses a problem on the end due to the increase in acidity.

Transfer into the P7 tank for bonding of 106 hl at 7.7° ac.

Little foam in the filler (1 cm at the surface). No foam during the filling (it disintegrates immediately), the acidity and the bonding limit this phenomenon.

1. Process for producing beer vinegar from beer, the process comprising the steps of;
a) partial bonding to reduce the content of acetic bacteria and to clarify the beer,
b) filtering the beer from step a) to remove the yeasts,
c) decarboxylation of the beer of step b),
d) gradual acetification of the beer of step c), until a product whose acetic degree is compatible with the designation “vinegar” is obtained, and
e) clarification of the product of step d) to remove the cloudiness.

2. A process according to claim 1, wherein the decarboxylation step is formed by injecting a separating gas.

3. A process according to claim 2, wherein the separating gas injected is nitrogen.

4. A process according to claim 3, wherein the injection of nitrogen is performed at a rate of 1 to 1.5 volumes of N₂ per volume of beer.

5. A process according to any one of claims 2 to 4, wherein the injection of gas is carried out in a conduit connecting the beer storage tank and the beer receiving tank, the point for injecting nitrogen into the conduit being sufficiently remote from the receiving tank to allow a good action of the nitrogen in the beer within the conduit.

6. A process according to claim 5, wherein the injection point is at least 15 m away from the filling tank.

7. A process according to either claim 5 or 6, wherein the filling of the receiving tank is performed tangentially to the wall of the tank, so as to create a vortex.

8. A process according to claim 7, wherein the filling of the receiving tank is performed in the top part of the tank.

9. A process according to any one of claims 1 to 8, wherein the residual CO₂ content of the beer after the decarboxylation step is less than or equal to 2 g/l of CO₂.

10. A process according to any one of claims 1 to 9, which includes a degassing step prior to the filtration step.

11. A process according to any one of claims 1 to 10, which includes, after the decarboxylation step and successively:
a denaturing step,
an acetification step,
an additional bonding step,
a filtration step,
an optional step of rectifying the alcoholic degree of the beer vinegar obtained in order to obtain an alcoholic degree of less than or equal to 6°,
a storage and/or packaging step.

12. A process according to claim 11, wherein the additional bonding step comprises the addition of overactivated adhesives.

13. Beer vinegar, produced by the process of any one of claims 1 to 12.

14. Plant for carrying out the process according to any one of claims 1 to 12, the plant comprising:
at least one beer storage tank,
at least one beer receiving tank connected to the storage tank via a conduit,
a nitrogen injector mounted on the conduit at a sufficient distance from the receiving tank to allow good dissolution of the nitrogen in the beer.

15. Plant according to claim 14, wherein the distance is at least 15 m.

16. Plant according to either claim 14 or 15, wherein the conduit opens substantially tantentially to the wall of the receiving tank, to create a vortex effect.
